(19) United States
(12) Patent Application Publication
(10) Pub. No.: US 2011/0254955 A1
(43) Pub. Date: Oct. 20, 2011

(54) Detachable Universal Electronic Door Viewer

(76) Inventor: Peter Chi-Chen Shen, Shanghai (CN)

(21) Appl. No.: 12/762,354

(22) Filed: Apr. 18, 2010

(51) Int. Cl. H04N 7/18; G08B 13/00

(52) U.S. Cl. 348/143; 340/541; 348/E07.085

(57) ABSTRACT

Full functional integration of six components: 1) a main electronic door viewer unit; 2) a wireless infrared outdoor detection system (detection and radio wave transmission unit from outdoor source); 3) a receiving unit attachment; 4) a re-transmission unit attachment; 5) a wireless alarm control unit; and 6) a control system to turn on any pre-set electrical appliances, remotely operable by devices (e.g. cellular phone). Integration achieved via wireless, radio wave, solar, and electronic technologies. Main body of the invention is the main electronic door viewer unit. The battery unit, receiving unit, transmission unit, and plugs for wire connectors are detachable/attachable by sliding tracks therein. Main body is installed on the door with the camera lens focused on the external scene, and the image display screen facing inwards for viewing purposes. Components 2-6 communicate with the main body upon visitor arriving on property and/or at the door, triggering pre-set alerts.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE COMPUTER PROGRAM LISTING COMPACT DISK APPENDIX

Not Applicable

### BACKGROUND OF INVENTION

The subject matter of the invention entitled “the Detachable Universal Electronic Door Viewer,” pertains to improving the traditional door viewer currently on the market with a door viewer with more robust features. The traditional door viewer in the marketplace is composed of lens assemblies that project an image of the visitor when viewed by the user on the other side of the door. By contrast, the Detachable Universal Electronic Door Viewer consists of six major components integrating wireless, radio wave, solar, and electronic technologies, so that said invention not only has enhanced door viewer functionality, but also intruder alert capabilities. The electronic door viewer main unit (Component 1, as identified in the Detailed Description section of this specification) is functional as a stand-alone unit when any or all of the five remaining components are not integrated). However, the preferred embodiment of present invention is usage with all components programmed, attached, and integrated. Thus, for the purposes of this specification, “the Detachable Universal Electronic Door Viewer” will refer to the invention in its preferred embodiment. Vice versa, reference to “invention” herein will refer to the “Detachable Universal Electronic Door Viewer” in its preferred embodiment.

Traditional door viewers consisting of a series of lens assemblies pose the following problems:
1) The angle of viewing is limited. Intruders can step to the side or duck down to hide from a user's line of vision;
2) Traditional door viewers, especially those on older homes, are not durable, making it possible for a stranger to poke something through the hole and injure the user;
3) Visitors can see the user approach the door viewer, as the user must be close to the eyepiece lens to view the visitor. The user's approach will obscure light (natural or artificial depending on time of day), and therefore visitors will be able to notice that the light through the lens darkens when the user looks through the eyepiece;
4) Due to loss of light through multiple lenses, the image of the visitor will be darker, therefore making the visitor hard to identify. If the diameter of the lens is widened to enhance brightness, the visitor will be able to see in from the outside; and
5) Limited functionality and mode of use.

All of the concerns described above pose a threat to the safety and privacy of the user. The invention addresses each of the aforementioned problems. Invention advantages are detailed in the Brief Summary of Invention section below.

### BRIEF SUMMARY OF INVENTION

The objective of the present invention is to enhance the safety and privacy of the user by providing a door viewer with robust features that eliminate the problems described above, integrate the latest technologies, and expand mode of use to include intruder detection and communication with other devices. These enhancements are achieved by integrating wireless, solar, radio wave, and electronic technologies. As components of the present invention are detachable, purchasers can make their purchase decision based on their own economic and safety considerations. The detachable nature of the invention allows it to be sold at various price points as an economical or high-end product.

The Detachable Universal Electronic Door Viewer in its preferred embodiment operates with all components (components are further explained in Detailed Description of this specification) integrated, as a multi-functional electronic door viewer and remotely operable intruder alert system with wireless data transmission to and from external devices, such as a pre-set mobile phone, a wirelessly programmed external movement detector, and other pre-set electronic appliances. With all or some units detached, the invention can operate as a single-function electronic door viewer, or an electronic door viewer and individual alarm unit, respectively.

The advantages of said invention include the following:
1) Expanded usage parameters. The Detachable Universal Electronic Door Viewer functions not only as an improved door viewer, but also as the control center of the intruder alert functions;
2) Enhanced viewing capability. The invention replaces the traditional door viewer, and is equipped with LEDs to increase visibility of the visitor at the door. It is also equipped with infrared LEDs to increase visibility in low light situations. The LEDs compensate for the loss of light that traditional door viewer lenses cause.
3) Image capture with date and time identification, and recording capability if pre-set to record;
4) User discretion. Users can approach the door without visitors being aware of the movement;
5) Image and voice transmission. As part of the intruder alert function, data can be transmitted to a pre-set cellular device;
6) Remotely operable. Enables users to monitor security of area away from property;
7) Interaction with other devices. Can be programmed to turn pre-set appliances on/off in the house. Also interacts with external movement detectors to warn user of intruders;
8) Detachable elements. The battery unit, receiving unit, transmission unit, plugs for wire connectors and cable connectors are all detachable and attachable via sliding tracks on the main electronic door viewer unit (component 1 as described in Detailed Description section of specification herein). This feature gives purchasers flexibility in buying decision and modes of use;
9) Easy installation. Individual users can easily mount and program the product.

### BRIEF DESCRIPTION OF SEVERAL VIEWS OF DRAWING

The drawings as part of this application aims to show various views of the Detachable Universal Electronic Door Viewer and the components comprising it; the detachability of said invention, and the manner in which components can be detached; a closer view of the video camera lens and LEDs it is equipped with; and the external movement detector device that it can interact with.

FIG. 1A is a front elevation view of the Detachable Universal Electronic Door Viewer with all components (refer to Detailed Description of the Invention section for components of invention) attached.

FIG. 1B is a left side elevation view of the Detachable Universal Electronic Door Viewer with all components (refer to Detailed Description of the Invention section for components of invention) attached.

FIG. 1C is a right side elevation view of the Detachable Universal Electronic Door Viewer with all components (refer to Detailed Description of the Invention section for components of invention) attached.

FIG. 1D is a top elevation view of the Detachable Universal Electronic Door Viewer with all components (refer to Detailed Description of the Invention section for components of invention) attached.

FIG. 1E is a bottom elevation view of the Detachable Universal Electronic Door Viewer with all components (refer to Detailed Description of the Invention section for components of invention) attached.

FIG. 1F is a rear elevation view of the Detachable Universal Electronic Door Viewer with all components (refer to Detailed Description of the Invention section for components of invention) attached.

FIG. 2A is a front elevation view to show all of the detachable components of said invention. The objective of FIG. 2A is to depict the manner in which the components can be detached or attached. These components can be slid in and out from the main electronic door viewer unit. Detaching all or some of the units below decrease the functionality of the electronic door viewer at the option of the purchaser based on his economic and safety considerations. The electronic door viewer main unit can function on a stand-alone basis without these attachments.

FIG. 2B is a front elevation view of all detachable components fully detached from the main electronic door viewer unit.

FIG. 2C is an auxiliary view showing the rear of the said fully detached components at an angle. In effect, this shows FIG. 2B rotated about the vertical axis.

FIG. 3A is a front elevation view of the video camera lens and LEDs, which are a part of the main electronic door viewer unit.

FIG. 3B is a right side elevation view of the Detachable Electronic Door Viewer with lens detached.

FIG. 3C is a left side elevation view of the video camera lens and cable tube, which is a part of the main electronic door viewer unit.

FIG. 3D is a rear elevation view of video camera lens.

FIG. 4 depicts a series of garden décor items with regular LED light, solar panel and wireless infrared movement detectors installed therein. These items communicate wirelessly with the detachable electronic universal door viewer, which serves as the control unit of the intruder alert function.

### DETAILED DESCRIPTION OF THE INVENTION

### Components of Invention

The Detachable Universal Electronic Door Viewer is comprised of 6 major components:
1) A main electronic door viewer unit, which can function on a stand-alone basis.
2) A wireless infrared outdoor detection system, which consists of a detection and radio wave transmission unit from an outdoor source.
3) A receiving unit attachment.
4) A re-transmission unit attachment.
5) A wireless alarm control unit.
6) A control system to turn-on any pre-set electrical appliances which can be remotely operated by communication devices, such as a cellular phone.
   The integration and interaction of these components makes it possible for the invention to carry out its various intruder alert and visitor detection functions.

The battery unit, receiving unit, transmission unit, plugs for wire connectors are all detachable and attachable by sliding tracks. When detached, component 1, the electronic door viewer itself, can still function independently. Component 1 serves as an enhanced door viewer to traditional door viewers in the market by providing a clear image of the visitor using a video camera lens. The LED lighting (infrared and regular LEDs) ensures that visitors are visible at any time of day. Image capture, recording functions, and date and time identification provides added security.

The detachable universal electronic door viewer is installed on the door with the camera lens focused on the external area outside of the door, and the image display screen facing inwards so that the user may be able to view the outside from behind the door. The invention serves as a much-improved replacement for the traditional door viewer with multiple lens assemblies.

### Function of Invention

With all components attached and integrated, the ideal function of the invention is as follows:
1) Upon entry onto property: the wireless infrared outdoor movement detection system (component 2) is installed within a garden décor item placed outside of the home or property. It is both solar and battery powered. The energy saving design of the printed circuit board regulates the power source. Battery power serves as a back-up for when solar power runs low, and the power sources are interchanged as appropriate. The movement detector alerts the user that someone is on property via wireless radio wave transmission to the receiving unit (component 3) on the Detachable Universal Electronic Door Viewer.
2) Upon approach to door:
   A) When a visitor stands outside the door for a given length of time, the video screen on the detachable electronic door viewer will turn on to show the external area, and a bell or chime will sound to alert the user and visitor. Alternatively, a LED light may turn on or flash as a silent mode option. These functions can be operated manually, by a light touch to the outer ring of the video camera, or can be programmed to function automatically. The said invention will also capture an image of the external scene, or record utilizing Secure Digital (SD) card technology if pre-set to do so. Infrared LED is equipped inside of video camera lens to ensure there is adequate lighting even when natural light is low. LED lighting equipped inside the video camera lens also serves as a pre-caution to visitor/intruder.
   B) The receiving unit attachment (component 3) sends a signal to the re-transmission unit attachment (component 4), allowing the image of the visitor and/or a pre-recorded message to be sent to your pre-programmed mobile device via GSM technology. If the user is not at home, he or she will be aware of who and when a visitor arrived on property. The re-transmission unit can also send a radio wave to an indoor alarm control unit (component 5), such as an existing door/window movement detector, panic alarm, etc. The indoor alarm control unit may be purchased from another source at the user's option, and programmed to work with invention described herein to serve as a multiple warning system. The indoor alarm control unit can be hidden within a decorative household item for added discretion.
   C) Using component 6, reverse dialing functions can be programmed to remotely operate electrical appliances as a part of monitoring/warning functions to deter intruders.

### Elements in Drawings

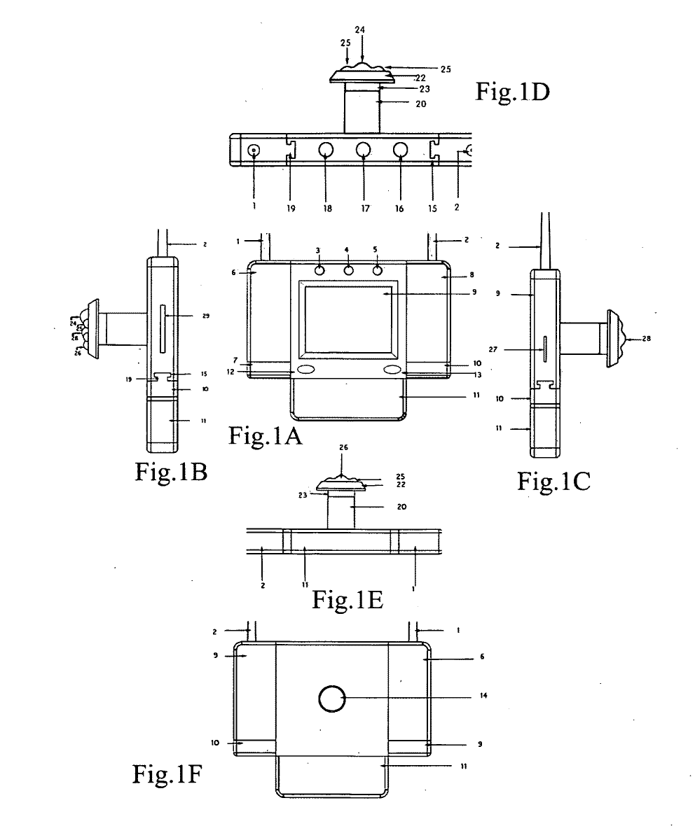

FIG. 1A is a front elevation view of the Detachable Universal Electronic Door Viewer with all components (refer to Detailed Description of the Invention section for components of invention) attached. Reference numbers 1 through 13 are used in FIG. 1A. The figure is showing the following parts of the invention:
1—Retractable/Extendable Receiving Antenna
2—Retractable/Extendable Transmission Antenna
3—Receiving LED Indicator
4–LED Indicator for Battery Power and PCB Connection
5—Transmission LED Indicator
6—Radio Wave Receiving Unit (from outside solar-powered detection system)
7—Plug/Slide-in Cable Connector—between door viewer main unit and receiving/transmission/battery case/cable connectors. (FIG. 1 reference #6, #7 and #9).
8—Radio. Wave Transmission Unit (to optional indoor alarm control unit)
9—Image Display Screen of Door Viewer
10—Plug/Slide-in Cable Connector—between door viewer main unit and receiving/transmission/battery case/cable connectors (FIG. 1 reference #8, #9 and #10).
11—Plug/Slide-in Battery Case
12—Speaker
13—Microphone

FIG. 1B is a left side elevation view of the Detachable Universal Electronic Door Viewer with all components (refer to Detailed Description of the Invention section for components of invention) attached. Reference numbers 2, 10, 11, 15, 19, and 29 are used in FIG. 1B. The figure is showing the following parts of the invention:
2—Retractable/Extendable Transmission Antenna
10—Plug/Slide-in Cable Connector—between door viewer main unit and receiving/transmission/battery case/cable connectors (FIG. 1 reference #8, #9 and #10).
11—Plug/Slide-in Battery Case
15—Female Slot—of all units (between receiving/transmission/battery case/cable connectors, and door viewer main unit)
19—Male Plug—of all units (between receiving/transmission/battery case/cable connectors and door viewer main unit)
29—SD Card Slot—for image and voice recording

FIG. 1C is a right side elevation view of the Detachable Universal Electronic Door Viewer with all components (refer to Detailed Description o f the Invention section for components of invention) attached. Reference numbers 2, 9, 10, 11, 27, and 28 are used in FIG. 1C. The figure is showing the following parts of the invention:
2—Retractable/Extendable Transmission Antenna
9—Image Display Screen of Door Viewer
10—Plug/Slide-in Cable Connector—between door viewer main unit and receiving/transmission/battery case/cable connectors (FIG. 1 reference #8, #9 and # 10).
11—Plug/Slide-in Battery Case
27—GSM Sim Card Slot—for direct transmission of image and voice to cellular device
28—Digital Video Camera Lens

FIG. 1D is a top elevation view of the Detachable Universal Electronic Door Viewer with all components (refer to Detailed Description of the Invention section for components of invention) attached. Reference numbers 1, 2, 15 through 20, and 22 through 25 are used in FIG. 1D. The figure is showing the following parts of the invention:
1—Retractable/Extendable Receiving Antenna
2—Retractable/Extendable Transmission Antenna
15—Female Slot—of all units (between receiving/transmission/battery case/cable connector's and door viewer's unit)
16—Transmission Power Switch
17—Door Viewer Main Power On/Off
18—Receiving Power Switch
19—Male Plug—of all units (between receiving/transmission/battery case/cable connectors and door viewer main unit)
20—Female Tube—for cable tunnel of video camera lens and other LEDs
22—Outer Ring of Camera Lens
23—Fine Tuning Ring—for proper lens positioning
24—Movement Detector
25—Infrared LED—to enhance visual imagery in lower lighting (2 of the 4 infrared LEDs are visible in this view)

FIG. 1E is a bottom elevation view of the Detachable Universal Electronic Door Viewer with all components (refer to Detailed Description o f the Invention section for components of invention) attached. Reference numbers 9 through 11, 20, 22, 23, 25, and 26 are used in FIG. 1F. The figure is showing the following parts of the invention:
11—Plug/Slide-in Battery Case
20—Female Tube—for cable tunnel of video camera lens and other LEDs
22—Outer Ring of Camera Lens
23—Fine Tuning Ring—for proper lens positioning
25—Infrared LED—to enhance visual imagery in lower lighting
26—LED Light—to provide adequate lighting for image capture

FIG. 1F is a rear elevation view of the Detachable Universal Electronic Door Viewer with all components (refer to Detailed Description of the Invention section for components of invention) attached. Reference numbers 1, 2, 6, 8 through 11, and 14 are used in FIG. 1F. The figure is showing the following parts of the invention:
1—Retractable/Extendable Receiving Antenna
2—Retractable/Extendable Transmission Antenna
6—Radio wave receiving unit (from outside solar powered detector system)
8—Radio Wave Transmission Unit (to optional indoor alarm control unit)
9—Image Display Screen of Door Viewer
10—Plug/Slide-in Cable Connector—between door viewer main unit and receiving/transmission/battery case/cable connector (FIG. 1 reference #8, #9 and #10).
11—Plug/Slide-in Battery Case
14—Rear Opening—cable tunnel of video camera lens and other LEDs

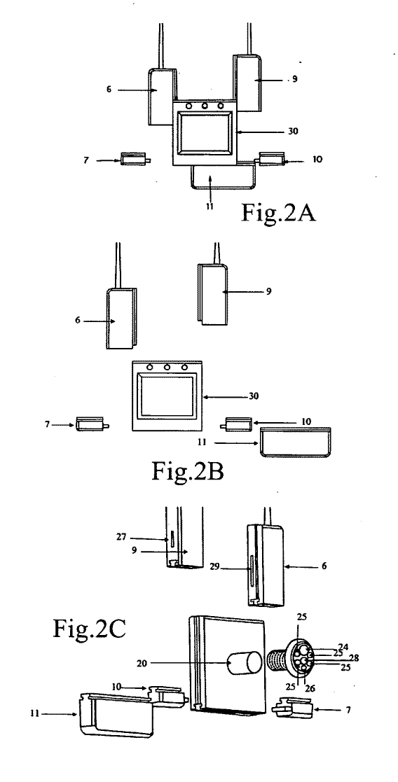

FIG. 2A is a front elevation view to show all of the detachable components of said invention. The objective of FIG. 2A is to depict the manner in which the components can be detached or attached. These components can be slid in and out from the main electronic door viewer unit. Detaching all or some of the units below decrease the functionality of the electronic door viewer at the option of the purchaser based on his economic and safety considerations. The electronic door viewer main unit can function on a stand-alone basis without these attachments. Reference numbers 6, 7, 9 through 11, and 30 are used in FIG. 2A. The figure is showing the following parts of the invention:
6—Radio Wave Receiving Unit (from outside solar powered detector system)
7—Plug/Slide-in Cable Connector—between door viewer main unit and receiving/transmission/battery case/cable connectors. FIG. 1 reference #6, #7 and #9).
9—Image Display Screen of Door Viewer
10—Plug/Slide-in Cable Connector—between door viewer main unit and receiving/transmission/battery case/cable connector (FIG. 1 reference #8, #9 and #10).
11—Plug/Slide-in Battery Case

FIG. 2B is a front elevation view of all detachable components fully detached from the main electronic door viewer unit. Refer to reference numbers and statements in paragraph above.

FIG. 2C is an auxiliary view showing the rear of the said fully detached components at an angle. In effect, this shows FIG. 2B rotated about the vertical axis. Reference numbers 6, 7, 9 through 11, 20, 24 through 29 are used in FIG. 2C:
6—Radio Wave Receiving Unit (from outside solar powered detector system)
7—Plug/Slide-in Cable Connector—between door viewer main unit and receiving/transmission/battery case/cable connectors. FIG. 1 reference #6, #7 and #9).
9—Image Display Screen of Door Viewer
10—Plug/Slide-in Cable Connector—between door viewer main unit and receiving/transmission/battery case/cable connector (FIG. 1 reference #8, #9 and #10).
11—Plug/Slide-in Battery Case
20—Female Tube—for cable tunnel of video camera lens and other LEDs
24—Movement Detector
25—Infrared LED—to enhance visual imagery in lower lighting
26—LED Light—to ensure external scene has adequate lighting
27—GSM Sim Card Slot—for direct transmission of image and voice to cellular device
28—Video Camera Lens
29—SD Card Slot—for image and voice recording

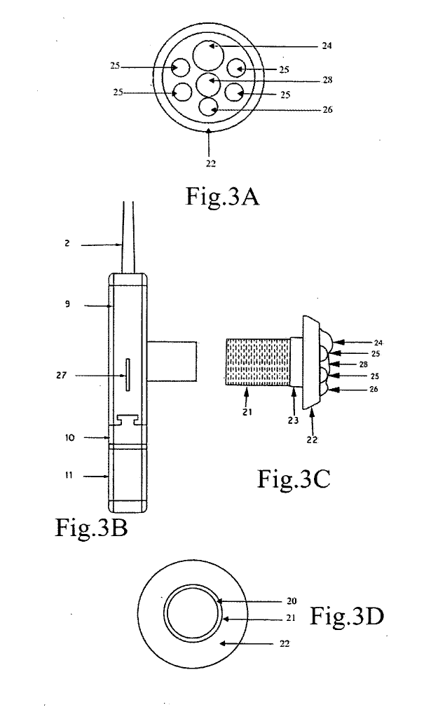

FIG. 3A is a front elevation view of the video camera lens and LEDs, which are a part of the main electronic door viewer unit. Reference numbers 22, 24 through 26, and 28 are used in FIG. 3A. The figure is showing the following parts of the invention:
22—Outer Ring of Camera Lens
24—Movement Detector
25—Infrared LED—to enhance visual imagery in lower lighting (all 4 infrared LEDs are visible in this view)
26—LED Light—to ensure external scene has adequate lighting
27—GSM Sim Card Slot—for direct transmission of image and voice to cellular device
28—Video Camera Lens

FIG. 3B is a right side elevation view of the Detachable Electronic Door Viewer with lens detached. Reference numbers 2, 9 through 11, and 27 are used in FIG. 3B. The figure is showing the following parts of the invention:
2—Retractable/Extendable Transmission Antenna
9—Image Display Screen of Door Viewer
10—Plug/Slide-in Cable Connector—between door viewer main unit and receiving/transmission/battery case/cable connector (FIG. 1 reference #8, #9 and #10)
11—Plug/Slide-in Battery Case
27—GSM Sim Card Slot—for direct transmission of image and voice to cellular device

FIG. 3C is a left side elevation view of the video camera lens and cable tube, which is a part of the main electronic door viewer unit. Reference numbers 21 through 26 are used in FIG. 3C. The figure is showing the following parts of the invention:
21—Male tube for cable tunnel of video camera lens
22—Outer Ring of Camera Lens
23—Fine Tuning Ring—for proper lens positioning
24—Movement Detector
25—Infrared LED—to enhance visual imagery in lower lighting (all 4 infrared LEDs are visible in this view)
26—LED Light—to ensure external scene has adequate lighting

FIG. 3D is a rear elevation view of video camera lens. Reference numbers 21 through 23 are used in this figure:
21—Male tube for cable tunnel of video camera lens
22—Outer Ring of Camera Lens
23—Fine Tuning Ring—for proper lens positioning

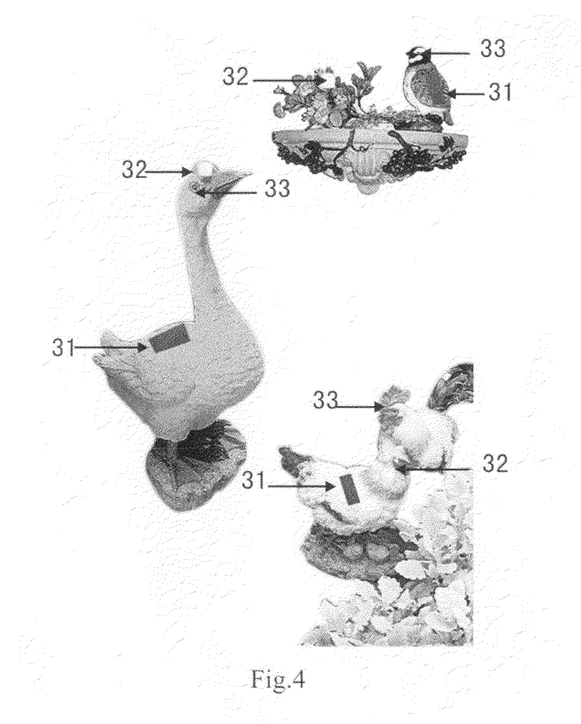

FIG. 4 depicts a series of garden décor items with regular LED light, solar panel and wireless infrared movement detectors installed therein. These items communicate wirelessly with the detachable electronic universal door viewer, which serves as the control unit of the intruder alert function. Reference numbers 31 through 33 are used for FIG. 4:
31—Outdoor Solar Panel
32—Outdoor Movement Detector
33—Outdoor LED Night Light

1. The Detachable Universal Electronic Door Viewer consists of a main electronic door viewer body with detachable and re-attachable receiving, transmission, re-transmission unit attachments, cable connectors, plugs, and battery case on a sliding track that integrates wireless, radio wave, solar, electronic, SD, and GSM technologies to communicate with a wireless outdoor movement detection system; internal alarm control units; and other devices including electrical appliances and communication devices; such that the invention operates as a multi-functional intruder alert system in addition to an improved type of, and replacement of, the traditional door viewer.

2. When any or all of unit attachments are removed, the main electronic door viewer functions on a stand-alone basis as an improved type of, and replacement of, the traditional door viewer by utilizing a video camera lens with LED bulbs, infrared LEDs, light sensitive and touch sensitive outer ring signaling an automatically or manually operated chime/bell; image display screen; microphone; and speaker to detect a visitor at the door via censor and movement detector, and capture an time-stamped an date-stamped image or recording of the visitor using Secure Digital technology.

3. A wireless infrared outdoor detection system installable on garden décor items shown in, but not limited to FIG. 4 and has a balancing circuit design such that the system can be solar-powered and run on battery back-up, interchanged as necessary; that has movement detection capabilities; communicable to the main electronic door viewer body stated in claim 1 via radio wave transmission to serve as an intruder or visitor alert warning to the user of said invention.

4. An interior wireless alarm control unit communicable with said invention via described in claim 1 via radio wave transmission such that a combination of alert functions occur simultaneously or in close succession to serve as a multi-warning intruder deterrent.

5. A control system communicable with said invention described in claim 1 to operate any pre-set electrical appliances such that these appliances can also be remotely operated by communication devices, such as a cellular phone, to serve as a multi-warning intruder deterrent and/or a convenient way for user to operate electrical appliances remotely.
